(19) United States
(12) Patent Application Publication
(10) Pub. No.: US 2008/0195287 A1
(43) Pub. Date: Aug. 14, 2008

(54) Method and Control Unit for Detecting the Closed State of a Clutch in a Drive Train of a Motor Vehicle

(75) Inventors: Antoon Nicolaas Janssen, Bruhl (DE); Thomas Kannen, Wiernsheim (DE)

Correspondence Address: LERNER GREENBERG STEMER LLP, P O BOX 2480, HOLLYWOOD, FL, 33022-2480, US

(73) Assignee: Dr. Ing. h.c.F. Porsche Aktiengesellschaft, Weissach (DE)

(21) Appl. No.: 12/025,802

(22) Filed: Feb. 5, 2008

(30) Foreign Application Priority Data
Feb. 13, 2007 (DE) 10 2007 006 976.8

(51) Int. Cl. G06F 19/00

(52) U.S. Cl. 701/67

(57) ABSTRACT

In a method for assessing a closed state of a clutch in a drive train of a motor vehicle, with which clutch a driver controls a frictional connection between an internal combustion engine and a change speed transmission of the motor vehicle, the assessment is carried out in dependence on a signal of a sensor which detects activation of the clutch. The method is distinguished by the fact that a difference in rotational speed which occurs across the clutch is determined and the assessment is additionally carried out in dependence on the difference in rotational speed. In addition, a control unit is configured to carry out the method.

### CROSS-REFERENCE TO RELATED APPLICATION

This application claims the priority, under 35 U.S.C. § 119, of German application DE 10 2007 006 976.8, filed Feb. 13, 2007; the prior application is herewith incorporated by reference in its entirety.

### BACKGROUND OF THE INVENTION

### Field of the Invention

The invention relates to a method for assessing a closed state of a clutch in a drive train of a motor vehicle. With the clutch a driver controls a frictional connection between an internal combustion engine and a change speed transmission of the motor vehicle. The assessment is carried out in dependence on a signal of a sensor which detects activation of the clutch.

Such a method and such a control unit are already used in motor vehicles which are produced in series. In the control of modern internal combustion engines, control unit routines are frequently carried out in order to improve the driving comfort. Examples of such routines are functions for load shock damping and anti-jolting functions. In such routines and functions, interventions into the control of the internal combustion engine which influence the torque generated by the internal combustion engine take place. The interventions take place in such a way that rotational oscillations of the drive train are damped and/or the excitation of such rotational oscillations is reduced. It goes without saying that interventions into the control of the internal combustion engine affect the rest of the drive train only when the friction clutch is closed. It is also self-evident that the interventions have to be matched to the moment of inertia of the drive train including the internal combustion engine since the natural frequencies are dependent on this moment of inertia.

A regular function of the aforesaid routines and functions therefore requires the control unit to know the closed state of the friction clutch. In the known subject matter, the control unit detects the closed state from the signal of a pedal travel sensor which changes its signal when the clutch pedal is activated. The known pedal travel sensor supplies a binary signal which changes its level when there is a slight deflection of the clutch pedal from its position of rest and in this way signals to the control unit either a closed clutch or an open clutch.

As a rule the pedal travel at which the binary signal changes its level will not coincide with the bite point of the clutch. In this context, the bite point of the clutch is understood to be the position of the clutch pedal at which the rotational speeds in front of and behind the clutch approximate when the transmission of torque starts. If the clutch pedal is depressed and is subsequently allowed to return to its position of rest, the period of time in which the clutch is actually open will be an entirely longer period of time for which the pedal travel sensor signals an open clutch. In other words, when the clutch pedal is depressed the pedal travel sensor reacts too early, while it reacts too late when the activation of the pedal is decreased.

This ensures, on the one hand, that the aforesaid interventions actually occur only when the clutch is closed, which is completely desirable. On the other hand, if the period of time after the activation of a clutch is considered these interventions could be activated earlier if the control unit had a better possible way of distinguishing a closed clutch from an open clutch.

### BRIEF SUMMARY OF THE INVENTION

It is accordingly an object of the invention to provide a method and a control unit for detecting the closed state of a clutch in a drive train of a motor vehicle that overcomes the above-mentioned disadvantages of the prior art methods and devices of this general type, which in each case permits improved differentiation between a closed clutch and an open clutch.

With the foregoing and other objects in view there is provided, in accordance with the invention, a method for assessing a closed state of a clutch in a drive train of a motor vehicle, in which a driver uses the clutch for controlling a frictional connection between an internal combustion engine and a change speed transmission of the motor vehicle. The method includes the steps of determining a difference in a rotational speed occurring across the clutch; and carrying out an assessment of the closed state in dependence on a signal of a sensor detecting activation of the clutch and in dependence on the difference in the rotational speed.

Determining a difference in the rotational speed which occurs across the clutch, that is to say a difference between a clutch input rotational speed and a clutch output rotational speed, permits reliable differentiation between a closed clutch and an open clutch if these respective states persist over a certain minimum time period.

This additional time condition takes into account moments of inertia acting in the drive train. Therefore, when the clutch opens, it takes several milliseconds, even under load, until the rotational speed of the internal combustion engine has risen to such an extent that the difference in rotational speed exceeds a predetermined threshold value. For these dynamic transitions between a closed clutch and an open clutch may therefore be advantageous to continue evaluating the signal of the pedal travel sensor which reacts virtually without inertia. This is significant above all for rapid switching processes in the change speed transmission.

Without the pedal travel sensor, the aforesaid comfort functions could still be active when rapid gear shifting is occurring and the clutch is opened. Since the internal combustion engine is, however, already decoupled from the rest of the drive train when the clutch is opened, and it is not braked by its moment of inertia, this could lead to undesired reactions of the internal combustion engine.

In contrast, the additional assessment in dependence on the difference in rotational speed provides the possibility of quickly detecting a transition in the opposite direction, that is to say from an open clutch to a closed clutch.

In accordance with an added mode of the invention, there is the step of generating a further signal characterizing a closed clutch if the sensor detects no activation of the clutch.

In accordance with another mode of the invention, there is the step of generating a further signal characterizing a closed clutch if the sensor detects activation of the clutch lasting for longer than a predetermined minimum period and an absolute value of the difference in the rotational speed drops below a predetermined threshold value.

In accordance with a further mode of the invention, there are the steps of generating another signal characterizing an open clutch if the sensor detects activation of the clutch and a predetermined delay time has passed since detection; and setting the predetermined minimum period to be longer than the predetermined delay time.

In accordance with another further mode of the invention, there is the step of generating a further signal characterizing an open clutch if the difference in the rotational speed across the clutch exceeds a predetermined threshold value.

In accordance with an added mode of the invention, there are the steps of sensing a rotational speed of the internal combustion engine as a first rotational speed; sensing a rotational speed of a transmission input shaft as a second rotational speed; and determining the difference in the rotational speed across the clutch as a difference between the first rotational speed and the second rotational speed.

In accordance with a concomitant mode of the invention, there are the steps sensing a rotational speed of the internal combustion engine as a first rotational speed; sensing a further rotational speed in the drive train at an output end of the change speed transmission; determining a rotational speed of the transmission input shaft as a second rotational speed from the further rotational speed and a transmission ratio; and determining the difference in the rotational speed across the clutch from a difference between the first rotational speed and the second rotational speed.

It goes without saying that the features which are mentioned above and the features which are to be explained below can be applied not only in the respect of the specified combinations but also in other combinations or alone without departing from the scope of the present invention.

Other features which are considered as characteristic for the invention are set forth in the appended claims.

Although the invention is illustrated and described herein as embodied in a method and a control unit for detecting the closed state of a clutch in a drive train of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is an illustration of a drive train of a motor vehicle as a technical field of the invention;

FIG. 2 is a block circuit diagram of an exemplary embodiment according to the invention; and

FIG. 3 is a detailed block circuit diagram of an embodiment of the invention.

### DETAILED DESCRIPTION OF THE INVENTION

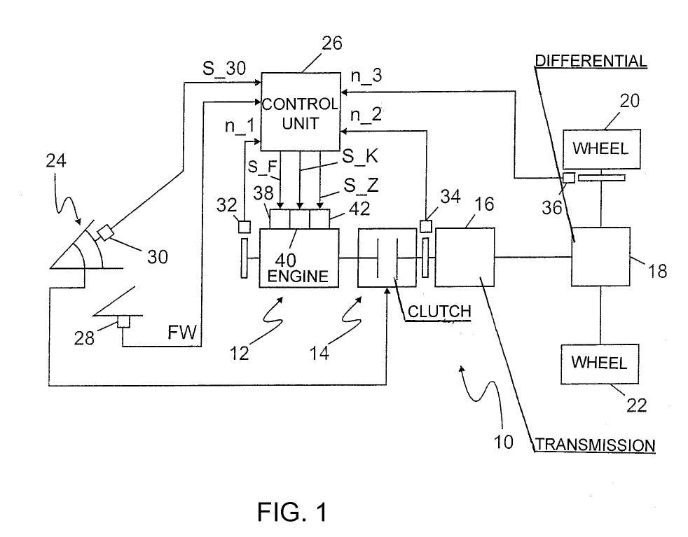

Referring now to the figures of the drawing in detail and first, particularly, to FIG. 1 thereof, there is shown a drive train 10 of a motor vehicle with an internal combustion engine 12, a clutch 14, a change speed transmission 16, a differential 18 and driven wheels 20, 22. The clutch 14 is a friction clutch which is activated by the driver of the motor vehicle. Customary friction clutches have at least one driver disk which is pressed onto a flywheel of the internal combustion engine 12 using a spring-loaded pressure plate. The driver disk is connected to a transmission input shaft in such a way that it can move axially but is fixed in terms of rotation. In the closed state of the clutch 14, the torque of the internal combustion engine 12 is transferred by a frictional connection into the driver disk of the clutch 14 and is transmitted from there to the transmission input shaft.

The opening and closing of the clutch 14 is carried out by the driver counter to the spring loading by activating a clutch pedal 24. The transmission of the pedal force to the clutch 14 is generally carried out by a hydraulic system.

The internal combustion engine 12 is controlled by a control unit 26 which for this purpose processes signals in which various operating parameters of the drive train 10 are modeled. In the illustration in FIG. 1 these are mainly signals of a driver request signal transmitter 28 which senses a torque request FW of the driver, the signal S_30 of a pedal travel sensor 30, which senses activation of the clutch pedal 24, a signal n_1 of a first rotational speed signal transmitter 34 which senses an internal-combustion-engine-end first rotational speed n_1 of the clutch 14 (clutch input rotational speed), a signal n_2 of a second rotational speed signal transmitter 34 which senses a change-speed-transmission-end second rotational speed n_2 of the clutch 14 (clutch output rotational speed), and as an alternative to or in addition to the second rotational speed signal transmitter 34, a signal n_3 of a wheel speed signal transmitter 36 which senses a rotational speed n_3 of a driven wheel 20 of the motor vehicle.

Provided that the control unit 26 knows the gear speed which is engaged in the change speed transmission 16, it can determine the rotational speed n_2 from the rotational speed n_3 and the present transmission ratio. Therefore, the use of the wheel speed signal transmitter 36, which is present in any case, for antilock brake systems and/or vehicle movement dynamics controllers has cost advantages which result from a possible saving by limiting the second rotational speed signal transmitter 34. Instead of the wheel speed it is also possible to use any further rotational speed in the drive train which is fixedly coupled to a rotational speed on an output side of the change speed transmission, for example the rotational speed of a velocity signal transmitter.

The pedal travel sensor 30 is preferably not implemented as an end position switch but rather supplies a change in signal when the clutch pedal 24 passes a predetermined pedal travel position which lies between the end positions. The pedal travel sensor 30 therefore constitutes an embodiment of a sensor 30 which detects an activation of the clutch 14.

In one preferred embodiment, the control unit 26 generates an internal signal KB which indicates activation of the clutch 14 by the driver if the pedal travel sensor 30 changes its binary output signal. The change occurs in an embodiment at approximately 5% of the time of the maximum pedal travel. Other values are also possible. In all cases it is important that activation of the clutch pedal 24 by the driver is signaled to the control unit 26 by the signal of the pedal travel sensor 30.

It goes without saying that modern drive trains 10 are equipped with a plurality of further sensors which are not illustrated here for reasons of clarity. Examples of such sensors are air mass flow rate meters, temperature sensors, pressure sensors etc. The enumeration of sensors and signal transmitters 28 to 36 is therefore not meant to be exhaustive.

It is also not necessary to provide a separate sensor for each operating parameter which is processed by the control unit 26 because the control unit 26 can model and/or calculate various operating parameters from other measured operating parameters using computing models.

This applies in particular to the clutch output rotational speed n_2 which, in one embodiment, is modeled by the control unit 26 from the signal n_3 of the wheel speed signal transmitter 36 taking into account a transmission ratio which is set in the change speed transmission 16, and the other transmission ratios in the drive train 10. The transmission ratio which is set in the change speed transmission 16 occurs, for example when the clutch 14 is closed, as a result of an assignment of rotational speed values n_3 and n_1 to a specific, set transmission ratio and therefore to a specific, engaged gear speed. This possibility results from the fact that various pairs of values of the aforesaid rotational speed values can be assigned in an unambiguous way to various, discrete transmission ratio stages in the change speed transmission 16.

From the received sensor signals S_30, n_1, n_2 and/or n_3, the control unit 26 assesses the closed state of the clutch 14 and forms, inter alia, manipulated variables for setting the torque which is to be generated by the internal combustion engine 12. In this context, in one preferred embodiment, the manipulated variables are formed with comfort functions which are activated or deactivated according to the closed state of the clutch 14.

Moreover, the control unit 26 is configured, in particular programmed, to carry out the method according to the invention or one of its embodiments and/or to control the corresponding method sequence.

The internal combustion engine 12 usually has, as actuator elements, subsystems 38, 40, 42, one subsystem 38 of which serves to control a charging of combustion chambers, one subsystem 40 of which serves to control a mixture formation, and one subsystem 42 of which serves to control an ignition of the combustion chamber charges. The subsystem 38 for controlling the charges has, in one embodiment, an electronically controlled throttle valve for controlling the air supply to the internal combustion engine 12 which is actuated with an actuation signal S_F. The subsystem 40 for controlling the mixture formation has, in one embodiment, a configuration of injectors by which fuel is metered into an intake manifold or into individual combustion chambers of the internal combustion engine 12 using actuation signals S_K. Actuation signals S_Z serve to trigger ignition processes in the combustion spaces.

The torque which is generated by the internal combustion engine 12 can be reduced, in particular, by restrictions on the combustion chamber charges and/or by switching off the fuel supply to one or more combustion chambers and/or by delaying the triggering of ignition processes with respect to an ignition time at which an optimum torque would be produced (adjustment of the ignition in the retarded direction).

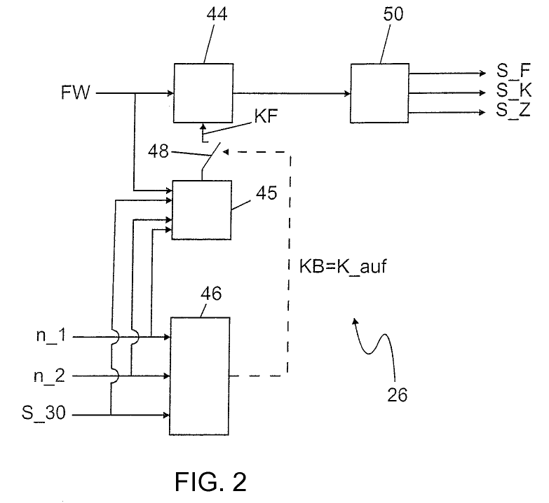

FIG. 2 illustrates an embodiment of the invention in the form of a block circuit diagram of the control unit 26. The individual blocks can be assigned here both to individual method steps and to function models of the control unit 26 so that FIG. 2 illustrates both method aspects and device aspects of the invention.

In particular, block 44 represents the formation of a setpoint value M_setp for the torque of the internal combustion engine 12 as a function of a driver request FW and/or as a function of requests KF which are formed in the control unit 26 for controlling the internal combustion engine 12. Such requests result, for example, from comfort functions such as the anti-jolting functions and routines and functions for load shock damping which are mentioned above as examples. In the embodiment in FIG. 2, such requests KF are formed by block 45, which generally represents the formation of internal torque requests KF by functions of the control unit 26.

In an assessment block 46, the assessment of the closed state of the clutch 14 takes place as a function of the signal S_30 of the pedal travel sensor 30 and the values of the rotational speeds n_1 and n_2 in the drive train 10 in front of and after the clutch 14. In this context, the assessment block 46 forms a difference dn in rotational speed across the clutch 14 as a difference between the values of the rotational speeds n_1 and n_2 and assesses the closed state of the clutch 14 as a function of the signal S_30 of the pedal travel sensor 30 and additionally as a function of the difference dn in rotational speed.

As a result of the assessment, the block 46 outputs a signal KB in which the detected closed state of the clutch 14 is modeled. In one embodiment, KB is a binary signal which assumes or is assigned a value K_zu when a clutch 14 is detected as being closed, and a value K_auf when a clutch 14 is detected as being open. In the embodiment in FIG. 2, the signal KB serves to actuate a software switch 48 with which torque requests KF of the aforesaid comfort functions or other functions of the control unit 26 which are formed in the block 45 can be sent to the block 44 as additional input variables. If the block 46 detects a closed clutch 14, it outputs a signal KB=K_zu, with which the software switch 48 is closed. In this case, the torque setpoint value M_setp is formed in the block 44 taking into account the additional requests KF. If, on the other hand, the block 46 detects an open clutch, it opens the switch 48 with a signal KB=K_auf and therefore deactivates, for example, one or more of the aforesaid comfort functions.

The setpoint value M_setp which is formed in the block 44 is transferred to a manipulated variable formation means 50, which forms therefrom the manipulated variables S_F and/or S_K and/or S_Z with which the subsystems 38 and/or 40 and/or 42 from FIG. 1 are actuated in such a way that the internal combustion engine 12 generates the required torque M_setp.

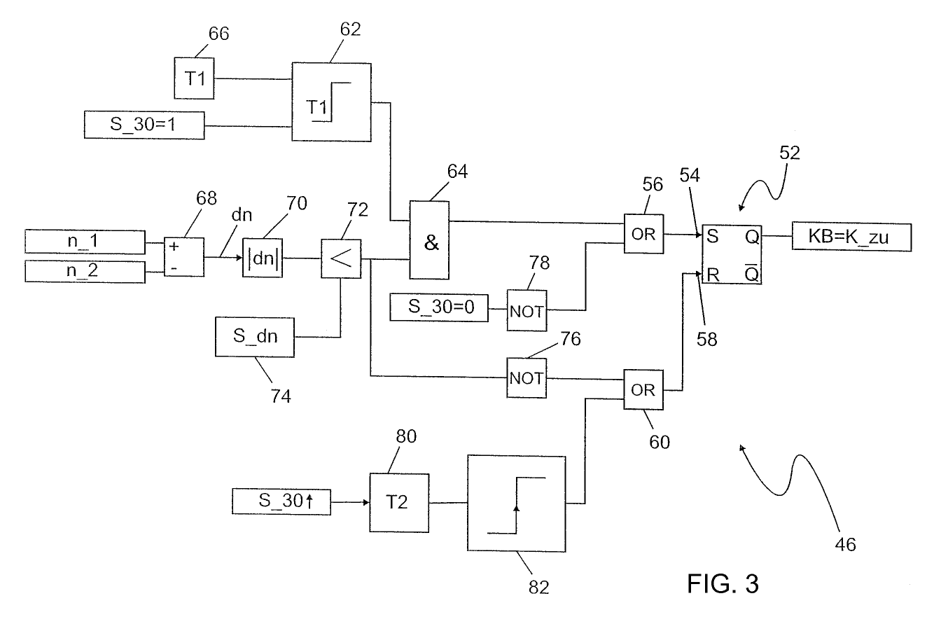

FIG. 3 shows a block circuit diagram of block 46 from FIG. 2 which assesses the closed state of the clutch 14. It also is the case here, as in FIG. 2, that the individual blocks can be assigned both to individual method steps and to function modules of the block 46 in the control unit 26. For this reason, FIG. 3 discloses both method aspects and device aspects of the invention.

In this context, the signal KB=K_zu, which represents a closed clutch 14, or a signal K_auf which represents an open clutch 14 is output with a flip-flop 52 whose setting input 54 is connected to the output of a first OR element 56, and whose resetting input 58 is connected to the output of a second OR element 60. The flip-flop 52 outputs the signal KB=K_zu if a logic 1 is present at its setting input 54. If, on the other hand, a logic 1 is present at the resetting input 58, the flip-flop 52 resets its output signal KB to the value KB=K_auf. In FIG. 3, the flip-flop 52 is illustrated in its set state in which it outputs KB=K_zu.

Both the first OR element 56 and the second OR element 60 each have two inputs so that a total of four situations result in which the flip-flop 52 either sets its output signal KB (KB=KB_zu) or resets it (KB=K_auf). In the text which follows, these four situations, which are modeled in different configurations of the input signals S_30, n_1 and n_2, are considered successively.

In the first situation, the signal S_30 of the pedal travel sensor 30 is intended to signal an open clutch 14; S_{—}30=1. A delay block 62, which has a low-pass filter characteristic, outputs this signal to an AND logic element 64 only if the pedal travel sensor 30 detects activation of the clutch 14 for longer than a specific minimum period T1. In one embodiment, T1 has a value of the order of magnitude of 500 ms. The value for T1 is obtained from a memory cell 66.

In parallel, a difference dn between the rotational speeds n_1 and n_2 is formed in a logic element 68. In an absolute value formation device 70 the absolute value of the difference dn is formed. A comparator 72 is used to compare the absolute value of the difference dn with a threshold value S_dn which is read out from a memory cell 74 and which represents a configurable differential rotational speed for determining a closed clutch 14.

If the absolute value of the difference in rotational speed dn is lower than this threshold value S_dn, the AND logic element 64 will transfer a logic one. The AND logic element 64 is therefore used to check whether the evaluation of the difference dn in rotational speed across the clutch 14 reveals a contradiction to the signal S_30=1 of the pedal travel sensor 30 which signals an open clutch 14.

Such a contradiction occurs, for example, if the driver allows his foot to rest on the clutch pedal 24 and in the process the clutch pedal 24 is deflected slightly out of its position of rest without being depressed. Since the pedal travel sensor 30 already responds when a comparatively small amount of pedal travel occurs, it signals in this case an open clutch 14 although actually there is still a frictional connection via the clutch 14. The frictional connection ensures that the rotational speeds n_1 and n_2 are approximated in front of and after the clutch 14 so that the evaluation of the difference dn in rotational speed makes it possible to conclude unambiguously that the clutch 14 is closed. This leads, via the AND logic element 64 and the first OR element 56, to the signal KB=K_zu being set by the flip-flop 52.

Therefore, if the pedal travel sensor 30 detects activation of the clutch 14 for longer than the specific minimum period T1 and if the absolute value of the difference dn in rotational speed drops below the predetermined threshold value S_dn, this structure generates a signal KB=K_zu which characterizes a closed friction clutch 14. The configurable value of the minimum period T1 therefore constitutes a minimum time in which the clutch 14, and therefore the drive train 10, can be assessed as being open without a different in rotational speed occurring.

A second situation is characterized by the fact that an appreciable difference dn in rotational speed occurs which exceeds the threshold value S_dn in the comparator 72. Then, the signal K_zu is not set by the AND logic element 64. Instead, in this case the comparator 72 generates a logic 0 which is converted into a logic 1 via an inverter 76, and leads, via the second OR element 60 to resetting of the flip-flop 52, and therefore causes a signal KB=K_auf which represents an open clutch 14 to be output.

Therefore, when the difference in rotational speed across the clutch 14 exceeds the predetermined threshold value S_dn this structure generates a signal KB=K_auf which characterizes an open clutch 14.

A third situation is characterized by the fact that the pedal travel sensor 30 signals a closed clutch 14, that is to say in particular outputs a signal S_30=0. This information is inverted in the inverter 78 and is fed, after inversion, as a logic one to the first OR element 56 which subsequently actuates the setting input 54 of the flip-flop 52. The flip-flop 52 then outputs the signal KB=K_zu which represents a closed clutch 14.

As a consequence, when the pedal travel sensor 30 does not detect any activation of the clutch 14 it generates a signal KB=K_zu which characterizes a closed friction clutch 14.

A fourth situation is characterized by the fact that an edge occurs in the signal S_30 of the pedal travel sensor 30 which signals an opening activation of the clutch pedal 24. The block 80 represents a predetermined delay time T2 which must expire before an edge detector 82 outputs a logic 1 in reaction to the edge. Then, after delay by the predetermined delay time T2 in the block 80, and after having been passed on via the edge detector 82 and the second OR element 60 to the resetting input 58 of the flip-flop 52, the aforesaid edge in the signal S_30 generates an output signal KB=K_auf which is representative of an open clutch 14. The predetermined delay time T_2 is preferably shorter than the specific minimum period T_1 and has a value of the order of magnitude of 150 ms in one embodiment.

Therefore, if the pedal travel sensor 30 detects activation of the clutch, and if a predetermined delay time T2 has expired since the detection, this structure generates a signal KB=K_auf which characterizes an open clutch 14.

Overall, the following behavior of the structure therefore occurs when starting, shifting a gear and when driving with the driver's foot resting on the clutch pedal 24:

When the vehicle starts, the signal S_30 of the pedal travel sensor 30 is initially equal to one when the clutch 14 is depressed. As soon as the clutch 14 engages and the vehicle starts to move, the rotational speeds n_1 of the internal combustion engine 12 and n_2 at the input of the change speed transmission 16 approximate. As soon as the difference dn in rotational speed then drops below the configurable threshold value S_dn, the signal KB=K_zu is generated by the flip-flop 52 which represents a closed clutch 14.

During the gear shifting process, the flip-flop 52 is reset by the rising edge of the signal S_30 after the clutch pedal 24 has been depressed and the configurable delay time T2 has expired. As a consequence, a signal KB=K_auf which represents an open clutch 14 is generated at least briefly. This signal opens the switch 48 in FIG. 2 so that the gear shifting process and the behavior of the internal combustion engine 12 during the gear shifting process are not disrupted by torque requests of the block 45 in FIG. 2.

When the clutch pedal 24 is depressed, the open clutch 14 would be detected by the comparator 72 even when a relatively large difference dn in rotational speed occurs. However, owing to the moments of inertia of the rotating masses involved, this would take place at a relatively late time so that the connection between the blocks 45 and 44 in FIG. 2 would be disconnected only at a comparatively late time. As a consequence, undesired fluctuations in rotational speed of the internal combustion engine 12 could occur during the gear shifting process.

When the driver is traveling with his foot resting on the clutch pedal 14 the clutch 14 would be assessed as being open if a corresponding edge occurs in the signal S_30 of the pedal travel sensor 30. In this context, the assessment is made by the blocks 80, 82, 60 and 52 in the structure in FIG. 3 even though the frictional connection is not interrupted. However, this is not problematic because in this case, in which the clutch 14 is not actually opened, the difference dn in rotational speed will be smaller than the threshold value S_dn, which then leads again to the respective assessment of the clutch 14 as being closed, in the way described in conjunction with the first situation.

1. A method for assessing a closed state of a clutch in a drive train of a motor vehicle, a driver using the clutch for controlling a frictional connection between an internal combustion engine and a change speed transmission of the motor vehicle, which comprises the steps of:
determining a difference in a rotational speed occurring across the clutch; and
carrying out an assessment of the closed state in dependence on a signal of a sensor detecting activation of the clutch and in dependence on the difference in the rotational speed.

2. The method according to claim 1, which further comprises generating a further signal characterizing a closed clutch if the sensor detects no activation of the clutch.

3. The method according to claim 1, which further comprises generating a further signal characterizing a closed clutch if the sensor detects activation of the clutch lasting for longer than a predetermined minimum period and an absolute value of the difference in the rotational speed drops below a predetermined threshold value.

4. The method according to claim 3, which further comprises generating another signal characterizing an open clutch if the sensor detects activation of the clutch and a predetermined delay time has passed since detection.

5. The method according to claim 4, which further comprises setting the predetermined minimum period to be longer than the predetermined delay time.

6. The method according to claim 1, which further comprises generating a further signal characterizing an open clutch if the difference in the rotational speed across the clutch exceeds a predetermined threshold value.

7. The method according to claim 1, which further comprises:
sensing a rotational speed of the internal combustion engine as a first rotational speed;
sensing a rotational speed of a transmission input shaft as a second rotational speed; and
determining the difference in the rotational speed across the clutch as a difference between the first rotational speed and the second rotational speed.

8. The method according to claim 1, which further comprises:
sensing a rotational speed of the internal combustion engine as a first rotational speed;
sensing a further rotational speed in the drive train at an output end of the change speed transmission;
determining a rotational speed of the transmission input shaft as a second rotational speed from the further rotational speed and a transmission ratio; and
determining the difference in the rotational speed across the clutch from a difference between the first rotational speed and the second rotational speed.

9. A control unit for assessing a closed state of a clutch in a drive train of a motor vehicle, with the clutch a driver controls a frictional connection between an internal combustion engine and a change speed transmission of the motor vehicle, the control unit comprising:
a controller programmed to:
determine a difference in a rotational speed occurring across the clutch; and
assess the closed state of the clutch in dependence on a signal of a sensor detecting activation of the clutch and in dependence on the difference in the rotational speed.

10. The control unit according to claim 9, wherein said controller is further programmed to generate a further signal characterizing a closed clutch if the sensor detects no activation of the clutch.

11. The control unit according to claim 9, wherein said controller is further programmed to generate a further signal characterizing a closed clutch if the sensor detects activation of the clutch lasting for longer than a predetermined minimum period and an absolute value of the difference in the rotational speed drops below a predetermined threshold value.

12. The control unit according to claim 11, wherein said controller is further programmed to generate another signal characterizing an open clutch if the sensor detects activation of the clutch and a predetermined delay time has passed since detection,

13. The control unit according to claim 12, wherein said controller is further programmed to set the predetermined minimum period to be longer than the predetermined delay time.

14. The control unit according to claim 9, wherein said controller is further programmed to generate a further signal characterizing an open clutch if the difference in the rotational speed across the clutch exceeds a predetermined threshold value.

15. The control unit according to claim 9, wherein said controller is further programmed to:
sense a rotational speed of the internal combustion engine as a first rotational speed;
sense a rotational speed of a transmission input shaft as a second rotational speed; and
determine the difference in the rotational speed across the clutch as a difference between the first rotational speed and the second rotational speed.

16. The control unit according to claim 9, wherein said controller is further programmed to:
sense a rotational speed of the internal combustion engine as a first rotational speed;
sense a further rotational speed in the drive train at an output end of the change speed transmission;
determine a rotational speed of the transmission input shaft as a second rotational speed from the further rotational speed and a transmission ratio; and
determine the difference in the rotational speed across the clutch from a difference between the first rotational speed and the second rotational speed.
